(19) United States
(12) Patent Application Publication
(10) Pub. No.: US 2026/0052422 A1
(43) Pub. Date: Feb. 19, 2026

(54) TRAINING DATA COLLECTION AND REPORTING

(71) Applicant: QUALCOMM Incorporated, San Diego, CA (US)

(72) Inventors: Rajeev KUMAR, San Diego, CA (US); Hamed PEZESHKI, San Diego, CA (US); Taesang YOO, San Diego, CA (US); Aziz GHOLMIEH, Del Mar, CA (US); Mohammed Ali Mohammed HIRZALLAH, San Diego, CA (US)

(21) Appl. No.: 19/284,373

(22) Filed: Jul. 29, 2025

Related U.S. Application Data
(60) Provisional application No. 63/684,238, filed on Aug. 16, 2024.

(51) Int. Cl. H04W 24/10

(52) U.S. Cl. CPC H04W 24/10

(57) ABSTRACT

Various aspects of the present disclosure generally relate to wireless communication. In some aspects, a user equipment (UE) may receive a configuration that indicates one or more measurement objects and one or more reporting or logging objects, wherein a first subset of the one or more measurement objects and the one or more reporting or logging objects are activated at the configuration and a second subset of the one or more measurement objects and the one or more reporting or logging objects are deactivated at the configuration. The UE may transmit, based at least in part on a trigger that activates the one or more measurement objects or the one or more reporting or logging objects, a measurement report that indicates training data based at least in part on the one or more measurement objects or the one or more reporting or logging objects. Numerous other aspects are described.

### CROSS-REFERENCE TO RELATED APPLICATION

This patent application claims priority to U.S. Provisional Patent Application No. 63/684,238, filed on Aug. 16, 2024, entitled “TRAINING DATA COLLECTION AND REPORTING,” and assigned to the assignee hereof. The disclosure of the prior application is considered part of and is incorporated by reference into this patent application.

### FIELD OF THE DISCLOSURE

Aspects of the present disclosure generally relate to wireless communication and specifically relate to techniques, apparatuses, and methods for training data collection and reporting.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some implementations, an apparatus for wireless communication includes one or more memories, and one or more processors coupled to the one or more memories, the one or more processors individually or collectively configured to: receive a configuration that indicates one or more measurement objects and one or more reporting or logging objects, wherein a first subset of the one or more measurement objects and the one or more reporting or logging objects are activated at a receipt of the configuration and a second subset of the one or more measurement objects and the one or more reporting or logging objects are deactivated at the receipt of the configuration; and transmit, based at least in part on a trigger that activates the one or more measurement objects or the one or more reporting or logging objects, a measurement report that indicates training data based at least in part on the one or more measurement objects or the one or more reporting or logging objects.

In some implementations, an apparatus for wireless communication includes one or more memories, and one or more processors coupled to the one or more memories, the one or more processors individually or collectively configured to: transmit a configuration that indicates one or more measurement objects and one or more reporting or logging objects, wherein a first subset of the one or more measurement objects and the one or more reporting or logging objects are activated at a receipt of the configuration and a second subset of the one or more measurement objects and the one or more reporting or logging objects are deactivated at the receipt of the configuration; and receive, based at least in part on a trigger that activates the one or more measurement objects or the one or more reporting or logging objects, a measurement report that indicates training data based at least in part on the one or more measurement objects or the one or more reporting or logging objects.

In some implementations, a method of wireless communication performed by a user equipment (UE) includes receiving a configuration that indicates one or more measurement objects and one or more reporting or logging objects, wherein a first subset of the one or more measurement objects and the one or more reporting or logging objects are activated at a receipt of the configuration and a second subset of the one or more measurement objects and the one or more reporting or logging objects are deactivated at the receipt of the configuration; and transmitting, based at least in part on a trigger that activates the one or more measurement objects or the one or more reporting or logging objects, a measurement report that indicates training data based at least in part on the one or more measurement objects or the one or more reporting or logging objects.

In some implementations, a method of wireless communication performed by a network node includes transmitting a configuration that indicates one or more measurement objects and one or more reporting or logging objects, wherein a first subset of the one or more measurement objects and the one or more reporting or logging objects are activated at a receipt of the configuration and a second subset of the one or more measurement objects and the one or more reporting or logging objects are deactivated at the receipt of the configuration; and receiving, based at least in part on a trigger that activates the one or more measurement objects or the one or more reporting or logging objects, a measurement report that indicates training data based at least in part on the one or more measurement objects or the one or more reporting or logging objects.

In some implementations, a non-transitory computer-readable medium storing a set of instructions for wireless communication includes one or more instructions that, when executed by one or more processors of a UE, cause the UE to: receive a configuration that indicates one or more measurement objects and one or more reporting or logging objects, wherein a first subset of the one or more measurement objects and the one or more reporting or logging objects are activated at a receipt of the configuration and a second subset of the one or more measurement objects and the one or more reporting or logging objects are deactivated at the receipt of the configuration; and transmit, based at least in part on a trigger that activates the one or more measurement objects or the one or more reporting or logging objects, a measurement report that indicates training data based at least in part on the one or more measurement objects or the one or more reporting or logging objects.

In some implementations, a non-transitory computer-readable medium storing a set of instructions for wireless communication includes one or more instructions that, when executed by one or more processors of a network node, cause the network node to: transmit a configuration that indicates one or more measurement objects and one or more reporting or logging objects, wherein a first subset of the one or more measurement objects and the one or more reporting or logging objects are activated at a receipt of the configuration and a second subset of the one or more measurement objects and the one or more reporting or logging objects are deactivated at the receipt of the configuration; and receive, based at least in part on a trigger that activates the one or more measurement objects or the one or more reporting or logging objects, a measurement report that indicates training data based at least in part on the one or more measurement objects or the one or more reporting or logging objects.

In some implementations, an apparatus for wireless communication includes means for receiving a configuration that indicates one or more measurement objects and one or more reporting or logging objects, wherein a first subset of the one or more measurement objects and the one or more reporting or logging objects are activated at a receipt of the configuration and a second subset of the one or more measurement objects and the one or more reporting or logging objects are deactivated at the receipt of the configuration; and means for transmitting, based at least in part on a trigger that activates the one or more measurement objects or the one or more reporting or logging objects, a measurement report that indicates training data based at least in part on the one or more measurement objects or the one or more reporting or logging objects.

In some implementations, an apparatus for wireless communication includes means for transmitting a configuration that indicates one or more measurement objects and one or more reporting or logging objects, wherein a first subset of the one or more measurement objects and the one or more reporting or logging objects are activated at a receipt of the configuration and a second subset of the one or more measurement objects and the one or more reporting or logging objects are deactivated at the receipt of the configuration; and means for receiving, based at least in part on a trigger that activates the one or more measurement objects or the one or more reporting or logging objects, a measurement report that indicates training data based at least in part on the one or more measurement objects or the one or more reporting or logging objects.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of beam management, in accordance with the present disclosure.

FIGS. 5-9 are diagrams illustrating examples associated with training data collection and reporting, in accordance with the present disclosure.

FIGS. 10-11 are diagrams illustrating example processes associated with training data collection and reporting, in accordance with the present disclosure.

FIGS. 12-13 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In an artificial intelligence or machine learning (AI/ML) based beam management, an AI/ML model may be deployed at a user equipment (UE) or a network node. The AI/ML model may enable the UE or the network node to determine one or more inferences or predictions based at least in part on data input to the AI/ML model. An input to the AI/ML model may include measurements associated with a first set of beams. For example, the network node may transmit one or more signals using respective beams from the first set of beams. The UE may perform measurements of the first set of beams to obtain a first set of measurements. The UE may input the first set of measurements into the AI/ML model along with information associated with the first set of beams and/or a second set of beams, such as a beam direction (e.g., spatial direction), beam width, beam shape, and/or other characteristics of the respective beams from the first set of beams and/or the second set of beams. Alternatively, the UE may provide the first set of measurements and the information to the network node, which may then input the first set of measurements and the information into the AI/ML model. The AI/ML model may output one or more predictions. The one or more predictions may include predicted measurement values associated with the second set of beams. The predicted measurement values may reduce a quantity of beam measurements, thereby conserving power at the UE and/or network resources that would have otherwise been used to measure all beams included in the first set of beams and the second set of beams.

In some examples, the first set of beams may be referred to as Set A beams and the second set of beams may be referred to as Set B beams. In some examples, the second set of beams (e.g., the Set B beams) may be a subset of the first set of beams (e.g., the Set A beams). In some other examples, the first set of beams and the second set of beams may be different beams and/or may be mutually exclusive sets. For example, the first set of beams (e.g., the Set A beams) may include narrow beams (e.g., refined beams or beams having a beam width that satisfies a first threshold) and the second set of beams (e.g., the Set B beams) may include wide beams (e.g., unrefined beams or beams having a beam width that satisfies a first threshold). In one example, the AI/ML model may perform spatial-domain beam predictions for beams included in the Set A beams based at least in part on measurement results of beams included in the Set B beams. As another example, the AI/ML model may perform temporal beam prediction for beams included in the Set A beams based at least in part on historic measurement results of beams included in the Set B beams.

The UE may perform the measurements based at least in part on a configuration of one or more measurement objects and one or more reporting objects. The UE may receive the configuration from the network node. The configuration may indicate, for a given measurement object of the one or more measurement objects, a first set of beams (e.g., Set A), a second set of beams (e.g., Set B), and an associated identifier. The configuration may further indicate, for a given measurement object, a reporting amount, a reporting interval, and a time series. The UE may perform the measurements in accordance with the configuration.

The UE may collect and report the measurements in accordance with an event-triggered measurement reporting. The UE may determine when a configured or triggered event occurs, and then the UE may collect and report the measurements based at least in part on the occurrence of the configured or triggered event. For example, the UE may be configured with various thresholds for serving cell measurements and/or neighbor cell measurements, and when one or more measurements satisfy the one or more thresholds, the UE may detect that the configured or triggered event has occurred and then the UE may perform the event-triggered measurement reporting. However, the event-triggered measurement reporting may be associated with configured or triggered events and may not involve non-configured events or non-triggered events. In other words, the UE may report measurements that are associated with the configured or triggered events, and the UE may not report measurements that are obtained outside of the configured or triggered events. The network node may not receive measurements that represent a distribution of measurements over an extended period of time. As a result, when the reported measurements are used by the network node to train a network-side AI/ML model (rather than a UE-side AI/ML model), the network-side AI/ML model may be trained in a manner that is biased toward the configured or triggered events, thereby affecting an accuracy of the network-side AI/ML model and degrading an overall system performance.

Further, the UE may collect and report the measurements in accordance with an event-triggered measurement reporting, regardless of a mobility of the UE. For example, even when the UE is non-mobile (e.g., not moving), the UE may collect and report the measurements in accordance with an event-triggered measurement reporting. However, since the UE is non-mobile, the reported measurements are likely to contain redundant data. The reporting of redundant measurements may waste resources at both the UE and the network node, thereby degrading the overall system performance.

Various aspects relate generally to training data collection and reporting. Some aspects more specifically relate to training data collection and reporting for network-side model training. In some examples, a UE may be configured, by a network, with one or more measurement objects and one or more reporting or logging objects. The one or more measurement objects may indicate, for a given measurement object, a first set of beams, a second set of beams, and an associated identifier. The one or more reporting or logging objects may indicate, for a given measurement object, a reporting amount, a reporting interval, and a time series. The one or more measurement objects and one or more reporting or logging objects may be part of a training data collection configuration, which may configure the UE to report measurements to be used for network-side AI/ML model training. In some aspects, when the UE is configured with the one or more measurement objects and the one or more reporting or logging objects, some measurement objects and reporting or logging objects may be initially activated, and other measurement objects and other reporting or logging objects may be initially deactivated. In other words, not all of the one or more measurement objects and the one or more reporting or logging objects may be automatically activated upon configuration.

In some aspects, when a trigger for data collection is satisfied, the one or more measurement objects and one or more reporting or logging objects may be activated, and the UE may collect, log, and/or report measurements in accordance with the one or more measurement objects and one or more reporting or logging objects. The trigger for data collection may be satisfied when the UE receives a medium access control (MAC) control element (MAC-CE) from the network. In other words, a receipt by the UE of the MAC-CE may trigger an activation or a deactivation of the one or more measurement objects and one or more reporting or logging objects, and the UE may collect, log, and/or report the measurements after receiving the MAC-CE.

In some aspects, the trigger for data collection may be satisfied when the UE receives higher layer signaling (e.g., system information) from the network. In other words, a receipt of the higher layer signaling may trigger the activation or the deactivation of the one or more measurement objects and one or more reporting or logging objects, and the UE may collect, log, and/or report the measurements after receiving the higher layer signaling.

In some aspects, the trigger for data collection may be satisfied in accordance with a probabilistic trigger for data collection, where the probabilistic trigger for data collection may be based at least in part on a network configuration. The probabilistic trigger for data collection may be based at least in part on random number generation for each reporting or logging object. Depending on the probabilistic trigger for data collection, the one or more measurement objects and one or more reporting or logging objects may be activated.

In some aspects, the trigger for data collection may be satisfied based at least in part on serving cell or beam measurements. When a difference between serving cell or beam measurements and neighbor cell or beam measurements satisfies a threshold, the one or more measurement objects and one or more reporting or logging objects may be activated.

The trigger for data collection, which may cause the one or more measurement objects and one or more reporting or logging objects to be activated or deactivated to enable the UE to collect, log, and/or report the measurements, may depend on the MAC-CE, the higher layer signaling, the probabilistic trigger for data collection, and/or the serving cell or beam measurements. Separate triggers for data collection may be defined, where the separate triggers may be sent by the network or configured by the network. The separate triggers may be defined for an initiating of measurement, logging, and/or reporting.

Particular aspects of the subject matter described in this disclosure can be implemented to realize one or more of the following potential advantages. In some examples, by configuring the one or more measurement objects and one or more reporting or logging objects and then activating the one or more measurement objects and one or more reporting or logging objects based at least in part on the trigger for data collection, the described techniques can be used by the UE to collect, log, and/or report the measurements to the network. The UE may collect, log, and/or report the measurements when the trigger for data collection is satisfied, instead of collecting and reporting measurements in response to a configured or triggered event. By utilizing the trigger for data collection, the network may receive measurements that represent an equal distribution of measurements over an extended period of time. In other words, the network may not only receive measurements when the configured or triggered event occurs, and then not receive any other measurements at other times. As a result, the measurements indicated by the UE may provide unbiased training data (e.g., training data that is not biased toward configured or triggered events). The unbiased training data may be used to more effectively train the network-side AI/ML model, as opposed to using the biased training data. The network-side AI/ML model that is trained using the unbiased training data may produce more accurate beam prediction results, thereby improving an overall system performance.

Further, by utilizing the trigger for data collection, the UE may be less likely to report redundant measurement data. When the UE is non-mobile, the trigger for data collection may not necessarily be satisfied. For example, the serving cell or beam measurements may be less likely to change when the UE is non-mobile as opposed to mobile, so the trigger data collection may not be satisfied and the UE may be less likely to report the redundant measurement data. By minimizing data redundancy, resource usage at the UE may be reduced, and network usage may be reduced because less but more relevant training data may be signaled to the network, thereby improving the overall system performance.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (cMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or AI/ML, among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

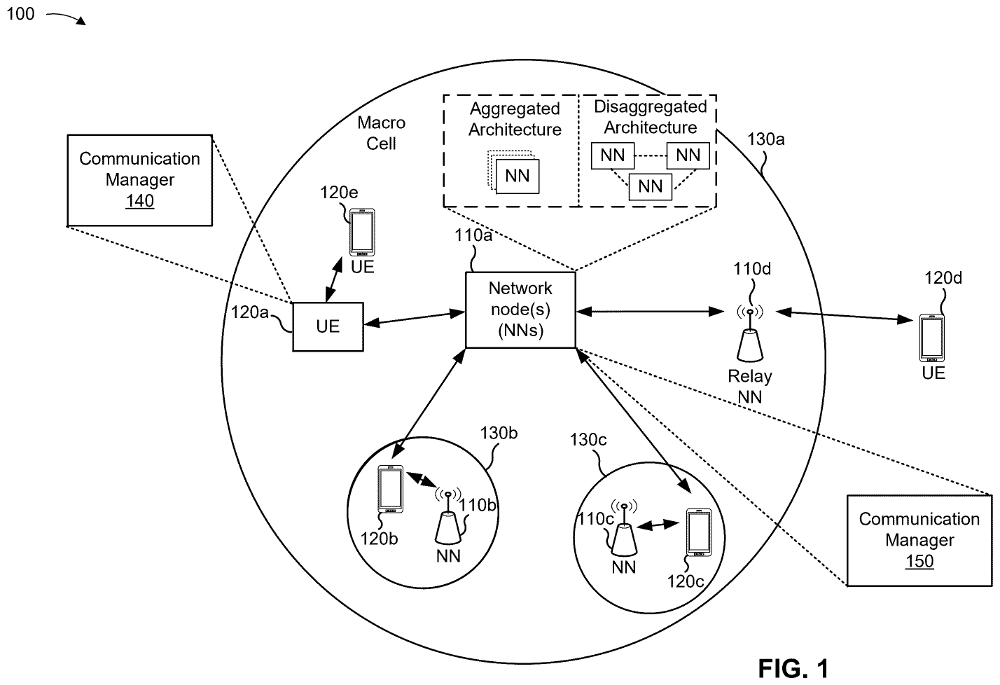

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a MAC layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally, or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally, or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally, or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, cMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or cMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120c in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a UE (e.g., the UE 120) may include a communication manager 140. As described in more detail elsewhere herein, the communication manager 140 may receive a configuration that indicates one or more measurement objects and one or more reporting or logging objects, wherein a first subset of the one or more measurement objects and the one or more reporting or logging objects are activated at a receipt of the configuration and a second subset of the one or more measurement objects and the one or more reporting or logging objects are deactivated at the receipt of the configuration; and transmit, based at least in part on a trigger that activates the one or more measurement objects or the one or more reporting or logging objects, a measurement report that indicates training data based at least in part on the one or more measurement objects or the one or more reporting or logging objects. Additionally, or alternatively, the communication manager 140 may perform one or more other operations described herein.

In some aspects, a network node (e.g., the network node 110) may include a communication manager 150. As described in more detail elsewhere herein, the communication manager 150 may transmit a configuration that indicates one or more measurement objects and one or more reporting or logging objects, wherein a first subset of the one or more measurement objects and the one or more reporting or logging objects are activated at a receipt of the configuration and a second subset of the one or more measurement objects and the one or more reporting or logging objects are deactivated at the receipt of the configuration; and receive, based at least in part on a trigger that activates the one or more measurement objects or the one or more reporting or logging objects, a measurement report that indicates training data based at least in part on the one or more measurement objects or the one or more reporting or logging objects. Additionally, or alternatively, the communication manager 150 may perform one or more other operations described herein.

As indicated above, FIG. 1 is provided as an example. Other examples may differ from what is described with regard to FIG. 1.

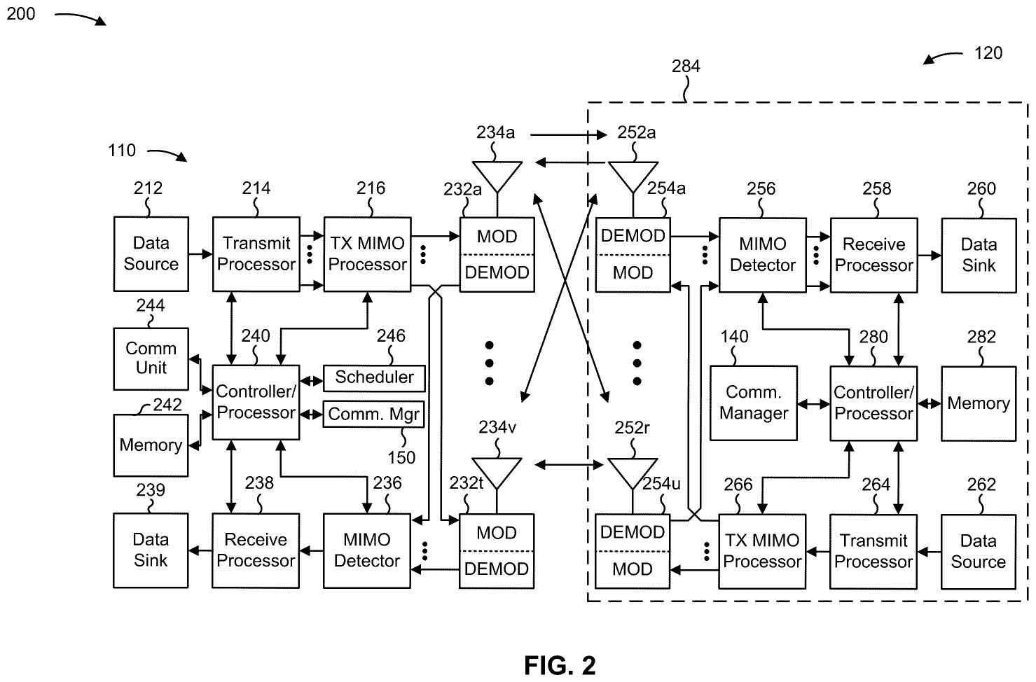

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC-CE communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

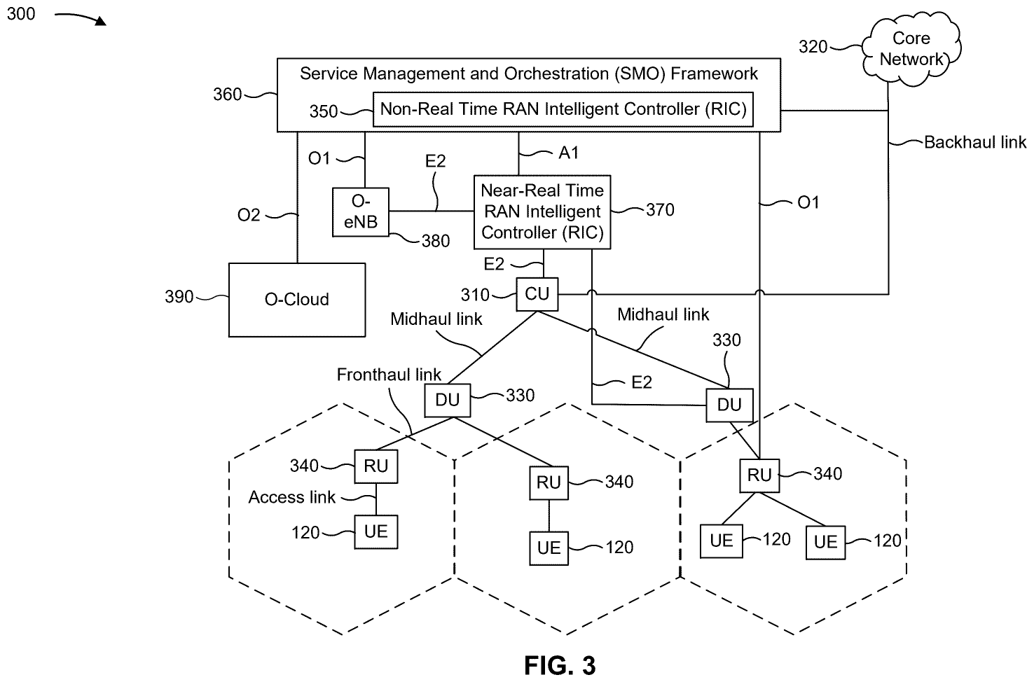

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally, or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

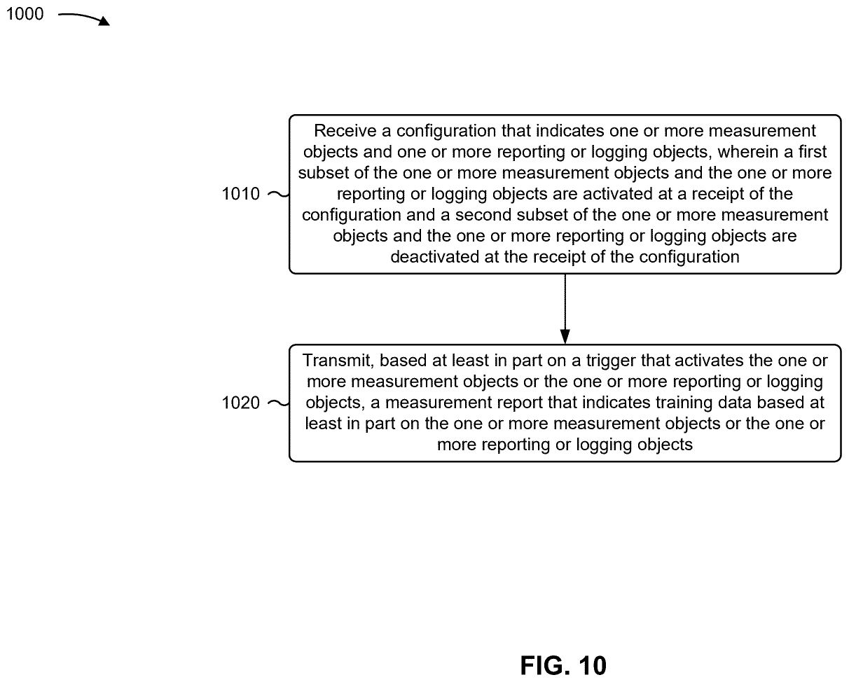

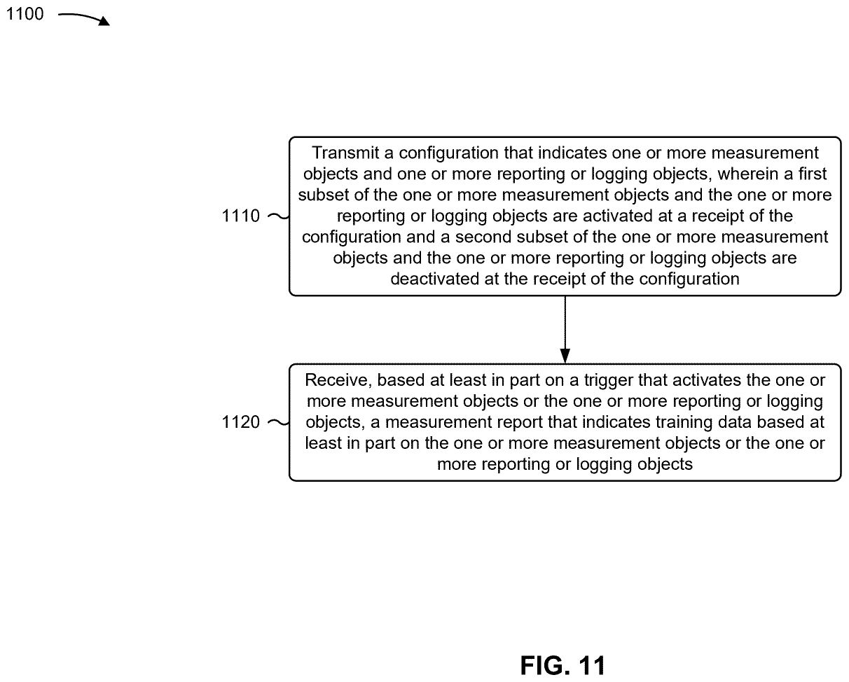

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with training data collection and reporting, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1000 of FIG. 10, process 1100 of FIG. 11, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1000 of FIG. 10, process 1100 of FIG. 11, or other processes as described herein. In some examples, executing instructions may include running the instructions, converting the instructions, compiling the instructions, and/or interpreting the instructions, among other examples.

In some aspects, a UE (e.g., the UE 120) includes means for receiving a configuration that indicates one or more measurement objects and one or more reporting or logging objects, wherein a first subset of the one or more measurement objects and the one or more reporting or logging objects are activated at a receipt of the configuration and a second subset of the one or more measurement objects and the one or more reporting or logging objects are deactivated at the receipt of the configuration; and/or means for transmitting, based at least in part on a trigger that activates the one or more measurement objects or the one or more reporting or logging objects, a measurement report that indicates training data based at least in part on the one or more measurement objects or the one or more reporting or logging objects. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting a configuration that indicates one or more measurement objects and one or more reporting or logging objects, wherein a first subset of the one or more measurement objects and the one or more reporting or logging objects are activated at a receipt of the configuration and a second subset of the one or more measurement objects and the one or more reporting or logging objects are deactivated at the receipt of the configuration; and/or means for receiving, based at least in part on a trigger that activates the one or more measurement objects or the one or more reporting or logging objects, a measurement report that indicates training data based at least in part on the one or more measurement objects or the one or more reporting or logging objects. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

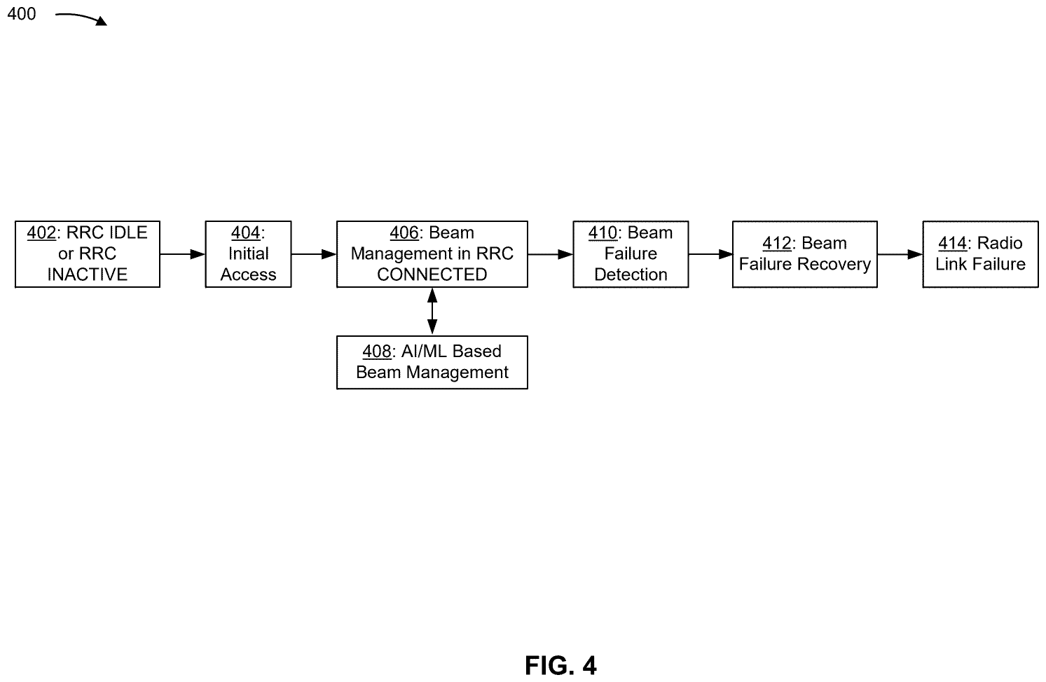

FIG. 4 is a diagram illustrating an example 400 of beam management, in accordance with the present disclosure.

As shown by reference number 402, a UE may initially be in an RRC idle state or an RRC inactive state. As shown by reference number 404, the UE may perform an initial access. As shown by reference number 406, the UE may perform a beam management after entering an RRC connected state. The beam management may include P1, P2, and/or P3 beam management procedures. The P1 beam management procedure may be a beam selection procedure, an initial beam acquisition procedure, a beam sweeping procedure, a cell search procedure, and/or a beam search procedure. The P2 beam management procedure may be a beam refinement procedure, a network node beam refinement procedure, a TRP beam refinement procedure, and/or a Tx beam refinement procedure. The P3 beam management procedure may be a beam refinement procedure, a UE beam refinement procedure, and/or an Rx beam refinement procedure. As shown by reference number 408, the UE may also perform beam management using an AI/ML-based approach. The beam management using the AI/ML-based approach may use an AI/ML model in a spatial domain (SD), a time domain (TD), and/or a frequency domain (FD), which may reduce signaling overhead and latency, and improve a beam selection accuracy. The AI/ML model may be associated with a lifecycle management, which may involve model training, model deployment, model inference, model monitoring, and/or model updating. As shown by reference number 410, the UE may perform a beam failure detection (BFD), which may be based at least in part on measurements obtained during the beam management after entering the RRC connected mode. As shown by reference number 412, the UE may perform a beam failure recovery (BFR) based at least in part on the BFD. As shown by reference number 414, when the BFR is not successful, the UE may declare a radio link failure (RLF).

As indicated above, FIG. 4 is provided as an example. Other examples may differ from what is described with regard to FIG. 4.

In an AI/ML enabled beam management, AI/ML based (downlink) spatial and temporal beam prediction may be employed at a network node and/or a UE. The AI/ML based spatial and temporal beam prediction may involve a layer 1 (L1) beam measurement prediction. In a first case, a spatial downlink beam prediction for a first set of beams (e.g., Set A beams) may be based at least in part on measurement results of a second set of beams (e.g., Set B beams). For example, the second set of beams may be synchronization signal block (SSB)-like wide beams, and the first set of beams may be CSI-RS-like narrow beams. As another example, the second set of beams may be narrow beams, and the first set of beams may be other narrow beams. In a second case, a temporal downlink beam prediction for the first set of beams may be based at least in part on historic measurement results of the second set of beams. For example, the first of set beams and the second set of beams may be the same (e.g., pure temporal beam prediction). As another example, the first set of beams and the second set of beams may be different from each other (e.g., spatial and temporal beam prediction). Further, an associated identifier may be provided for achieving consistency between training and inference.

The UE may perform a training data collection reporting to the network node. The UE may report multiple instances of logged L1 measurement results to the network node via RRC signaling. The network node may configure the UE to report the multiple instances of the logged L1 measurement results. In some cases, a single RRC message may not be sufficient and multiple RRC messages may be needed to report the multiple instances of the logged L1 measurement results. A minimization of drive tests (MDT) functionality may be used as a framework for operations, administration and maintenance (OAM)-centric data collection for the training of a network-side model. The MDT functionality may be enhanced to support periodic reporting, event-based reporting, and/or network-request-based reporting.

The network node may configure the UE with one or more measurement objects, where layer 3 (L3) measurements may be activated on configuration. The network node may configure the UE with one or more reporting or logging objects, where L3 reporting objects may be activated on configuration, and where periodic or event triggers may be supported. In other words, the network node may configure the UE to obtain measurements and then report the measurements in accordance with configured measurement objects and configured reporting objects, respectively.

The UE may transmit a UE-initiated or event-driven performance monitoring report to the network node. The network node may activate or deactivate, for the UE, a semi-persistent CSI reporting on a PUCCH. The network node may transmit, to the UE, a semi-persistent CSI reporting on PUCCH activation/deactivation MAC-CE or an enhanced semi-persistent CSI reporting on PUCCH activation/deactivation MAC-CE. When the UE receives such a MAC-CE from the network node, the UE may perform the semi-persistent CSI reporting via the PUCCH.

For example, when a MAC entity of the UE receives the semi-persistent CSI reporting on PUCCH activation/deactivation MAC-CE or the enhanced semi-persistent CSI reporting on PUCCH activation/deactivation MAC-CE on a serving cell, the MAC entity may indicate to lower layers information regarding the semi-persistent CSI reporting on PUCCH activation/deactivation MAC-CE or the enhanced semi-persistent CSI reporting on PUCCH activation/deactivation MAC-CE.

The UE may perform a training data logging for a network-side model training. In some cases, logged training data at the UE may be redundant data. For example, the UE may not be moving for a certain period of time, but the UE may still periodically obtain the logged training data for the network-side model training. Resources at the UE and/or at the network node may be wasted in obtaining and reporting such redundant logged training data. Further, the logged training data may be reported by the UE to the network node in accordance with an event-trigger reporting, where the logged training data may then be used for the network-side model training. In this example, the logged training data may be associated with only triggered or configured events, such that the logged training data may not provide a whole distribution of measurements over the certain period of time. The logged training data may be biased toward the triggered or configured events. As a result, when the logged training data is used for the network-side model training, a network-side model may be inadequately trained, thereby degrading an overall system performance.

In various aspects of techniques and apparatuses described herein, a UE may receive, from a network node, a configuration that indicates one or more measurement objects and one or more reporting or logging objects. A first subset of the one or more measurement objects and the one or more reporting or logging objects may be activated at a receipt of the configuration and a second subset of the one or more measurement objects and the one or more reporting or logging objects may be deactivated at the receipt of the configuration. A trigger for training data collection may activate the one or more measurement objects and/or the one or more reporting or logging objects. The trigger for data collection may be configured to activate the one or more measurement objects at L1 or L3, and the trigger for data collection may be configured to activate the one or more reporting or logging objects at L1 or L3. The UE may receive, from the network node, a MAC-CE that triggers the one or more measurement objects and/or the one or more reporting or logging objects to be activated. The UE may receive, from the network node, a higher layer signaling or system information that triggers the one or more measurement objects and/or the one or more reporting or logging objects to be activated. The trigger for training data collection may be a probabilistic trigger for data collection. The trigger for training data collection may be based at least in part on one or more measurements of serving cells or beams. The UE may transmit, to the network node and based at least in part on the trigger for training data collection that activates the one or more measurement objects and/or the one or more reporting or logging objects, a measurement report. The measurement report may indicate training data based at least in part on the one or more measurement objects and/or the one or more reporting or logging objects. The UE, when transmitting measurements as part of the measurement report, may indicate a number of samples at a defined interval based at least in part on a network configuration or a UE implementation. In some cases, the UE may log the measurements for subsequent transmission based at least in part on the one or more measurement objects and/or the one or more reporting or logging objects. The network node may receive the measurement report that indicates the training data from the UE. The network node may use the training data for a network-side model training.

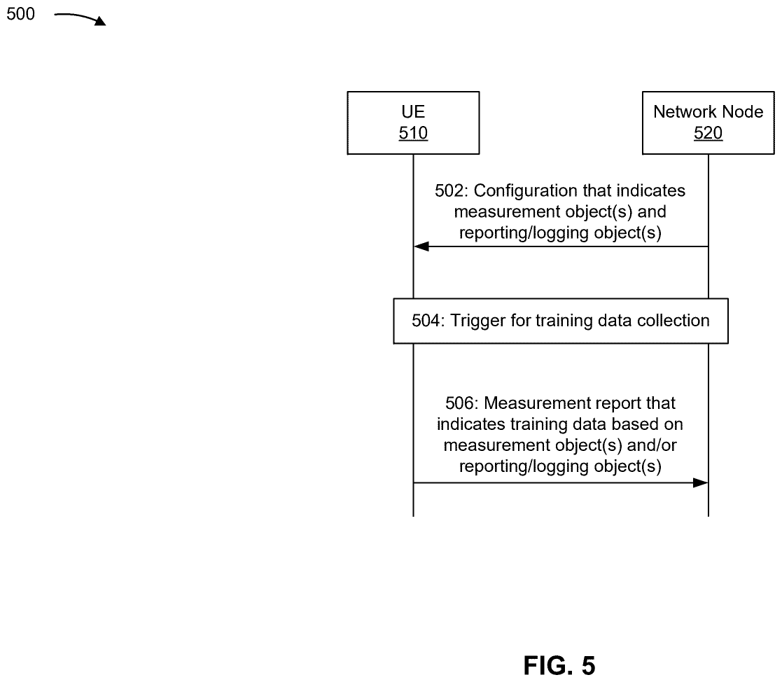

FIG. 5 is a diagram illustrating an example 500 associated with training data collection and reporting, in accordance with the present disclosure. As shown in FIG. 5, example 500 includes communication between a UE 510 (e.g., UE 120) and a network node 520 (e.g., network node 110). In some aspects, the UE 510 and the network node 520 may be included in a wireless network, such as wireless network 100.

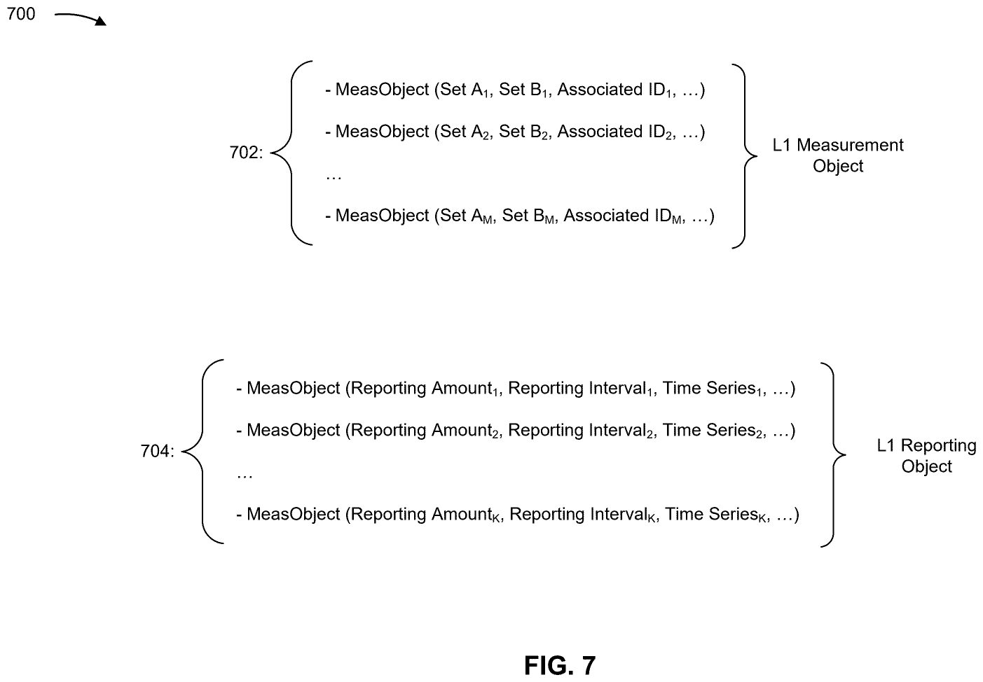

As shown by reference number 502, the UE 510 may receive, from the network node 520 and via RRC signaling, a configuration that indicates one or more measurement objects and one or more reporting or logging objects, where a first subset of the one or more measurement objects and the one or more reporting or logging objects may be activated at a receipt of the configuration and a second subset of the one or more measurement objects and the one or more reporting or logging objects may be deactivated at the receipt of the configuration. The UE 510 may be configured with the one or more measurement objects via the RRC signaling. The UE 510 may be configured with the one or more reporting or logging objects via the RRC signaling. In some aspects, the one or more measurement objects may include L1 measurement objects, and the one or more reporting or logging objects may include L1 reporting or logging objects. In some aspects, the one or more measurement objects may include L1 measurement objects, and the one or more reporting or logging objects may include L3 reporting or logging objects. In some aspects, the one or more measurement objects may include L3 measurement objects, and the one or more reporting or logging objects may include L3 reporting or logging objects. The one or more measurement objects and/or the one or more reporting or logging objects are further described in relation to FIGS. 7-9.

In some aspects, after the configuration is received, certain measurement objects may be activated or deactivated and certain reporting or logging objects may be activated or deactivated, depending on a network implementation. For example, the one or more measurement objects and/or the one or more reporting or logging objects may be deactivated upon receiving the configuration.

As shown by reference number 504, the UE 510 may detect a trigger for training data collection. The trigger for training data collection may activate the one or more measurement objects and/or the one or more reporting or logging objects. For example, the trigger for training data collection may activate the one or more measurement objects at L1 or L3, and the trigger for training data collection may activate the one or more reporting or logging objects at L1 or L3. The one or more measurement objects and/or the one or more reporting or logging objects may be activated by a serving cell associated with the network node 520. In some aspects, the UE 510 may receive, from the network node 520, a MAC-CE that triggers the one or more measurement objects and/or the one or more reporting or logging objects to be activated. A receipt of the MAC-CE may trigger training data collection. The MAC-CE may indicate, for the one or more measurement objects and/or the one or more reporting or logging objects to be activated, a serving cell identifier, a measurement object identifier, a reporting or logging object identifier, and/or an activation or deactivation status. In some aspects, the UE 510 may receive, from the network node 520, a higher layer signaling or system information that triggers the one or more measurement objects and/or the one or more reporting or logging objects to be activated. A receipt of the higher layer dedicated signaling or the system information may trigger the training data collection. The UE 510 may receive the system information via a periodic broadcast or via an aperiodic broadcast. The system information may indicate, for the one or more measurement objects and/or the one or more reporting or logging objects to be activated, a measurement object identifier, a reporting or logging object identifier, and/or an activation or deactivation status. In some aspects, the trigger for training data collection may be a probabilistic trigger for data collection. The probabilistic trigger for data collection may be based at least in part on a network configuration. In some aspects, the trigger for training data collection may be based at least in part on one or more measurements of serving cells or beams.

In some aspects, the one or more measurement objects and/or the one or more reporting or logging objects may be activated using the MAC-CE, in accordance with the trigger for training data collection. The network node 520 may transmit, to the UE 510, the MAC-CE to randomly trigger the one or more measurement objects and/or the one or more reporting or logging objects. The MAC-CE may indicate the serving cell identifier, which may indicate the serving cell for which the MAC-CE is to be applied. The MAC-CE may indicate the measurement object identifier, which may identify a measurement object to be applied. The MAC-CE may indicate the reporting or logging object identifier, which may indicate a reporting or logging object to be applied. The MAC-CE may indicate a status, which may be associated with an activation or a deactivation. The MAC-CE may activate or deactivate the one or more measurement objects and/or the one or more reporting or logging objects.

In some aspects, when a MAC entity of the UE 510 receives the MAC-CE on the serving cell, where the MAC-CE may be associated with a training data collection and reporting/logging, the MAC entity may indicate to measure objects (e.g., L1 measurement objects) to lower layers, and the MAC entity may indicate to reporting or logging objects (e.g., L3 reporting or logging layers) to upper layers. In some aspects, when the MAC entity of the UE 510 receives the MAC-CE on the serving cell, where the MAC-CE may be associated with the training data collection and reporting/logging, the MAC entity may indicate to measure objects (e.g., L3 measurement objects) to upper layers, and the MAC entity may indicate to reporting or logging objects (e.g., L3 reporting or logging layers) to upper layers.

In some aspects, the one or more measurement objects and/or the one or more reporting or logging objects may be activated using the higher layer signaling, in accordance with the trigger for training data collection. The network node 520 may transmit, to the UE 510, the higher layer signaling to randomly trigger the one or more measurement objects and/or the one or more reporting or logging objects. The higher layer signaling may include RRC signaling or system information. In some aspects, the serving cell may trigger a random measurement and reporting/logging object at the UE 510 using the system information (e.g., a system information block (SIB)). The SIB may be periodically broadcasted when a configured measurement and reporting/logging object is to be activated or deactivated. Alternatively, the SIB may be aperiodically broadcasted when the configured measurement and reporting/logging object is to be activated or deactivated. In some aspects, the higher layer signaling, such as dedicated RRC signaling (e.g., a short RRC message), may be transmitted when the configured measurement and reporting/logging object is to be activated or deactivated. In some aspects, the higher layer signaling (e.g., the RRC signaling or the system information) may indicate the measurement object identifier, the reporting or logging object identifier, and/or the status (e.g., activate or deactivate).

In some aspects, the one or more measurement objects and/or the one or more reporting or logging objects may be activated using the probabilistic trigger for data collection. The probabilistic trigger for data collection may occur at the UE 510, but may be based at least in part on a network configuration. The network node 520 may provide the UE 510 with a time series for data collection (rather than a periodic or an event-driven trigger), for each reporting or logging object. The UE 510 may be configured to generate time series for training data collection for each reporting or logging object. The UE 510 may perform a periodic data collection with probabilistic models. For example, for each reporting or logging object, the UE 510 may generate a random number and determine whether to perform measurement and reporting/logging based at least in part on the generated random number and the probabilistic models.

In some aspects, the one or more measurement objects and/or the one or more reporting or logging objects may be activated using RSRP/RSRQ measurement based triggers, in accordance with the trigger for training data collection. The UE 510 may measure an absolute RSRP/RSRP of the serving cell (or serving beam), or alternatively, the UE 510 may measure the absolute RSRP/RSRQ for a number of cells or beams (e.g., top K cells/beams). In some cases, the UE 510 may randomize measurements with respect to the serving cell (or serving beam). When a difference between the absolute RSRP/RSRP of the serving cell (or serving beam) versus other neighboring cells or beams satisfies a threshold, the one or more measurement objects and/or the one or more reporting or logging objects may be activated.

As shown by reference number 506, the UE 510 may transmit, to the network node 520 and based at least in part on the trigger for training data collection that activates the one or more measurement objects and/or the one or more reporting or logging objects, a measurement report. The measurement report may indicate training data based at least in part on the one or more measurement objects and/or the one or more reporting or logging objects. The training data may include measurements captured by the UE 510, where the measurements may be captured based at least in part on the one or more measurement objects and/or the one or more reporting or logging objects. In some aspects, the UE 510 may log the measurements for subsequent transmission based at least in part on the one or more measurement objects and/or the one or more reporting or logging objects. For example, the UE 510 may log the measurements and then transmit the measurement report at a later time. In some aspects, the UE 510, when transmitting the measurement report, may indicate a number of samples at a defined interval based at least in part on a network configuration or a UE implementation. The number of samples may correspond to a number of measurements taken by the UE 510. The network node 520 may receive the measurement report that indicates the training data, and the network node 520 may use the training data for a network-side AI/ML model training. For example, the network node 520 may train an AI/ML based beam prediction model using the training data received from the UE 510.

In some aspects, after satisfying the trigger for training data collection, a periodicity and/or a number of samples to report or log may be defined for the UE 510. For example, each time a measurement and reporting/logging interval is activated, the UE 510 may perform a configured number of reporting/logging measurements at a configured interval. The UE 510 may transmit the measurements in accordance with the periodicity and/or the number of samples to report, where the network node 520 may use such measurements for the network-side AI/ML model training.

In some aspects, when the UE 510 transmits the measurement report based at least in part on measured RSRPs/RSRQs, the number of samples that are reported by the UE 510 may depend on an RSRP/RSRQ range that is associated with the measured RSRPs/RSRQs. The number of samples in a given RSRP/RSRQ range may be configured by the network node 520. Within each RSRP/RSRQ range, different numbers of samples may be configured to be collected (in some cases, at different periodicities). The network node 520 may derive RSRP/RSRQ ranges using coverage statistics. In some aspects, the number of samples in each RSRP/RSRQ range may depend on a UE implementation. The UE 510 may collect statistics regarding an amount of time the UE 510 spends in every range, and the UE 510 may be able to dynamically adjust its collection percentages.

As indicated above, FIG. 5 is provided as an example. Other examples may differ from what is described with regard to FIG. 5.

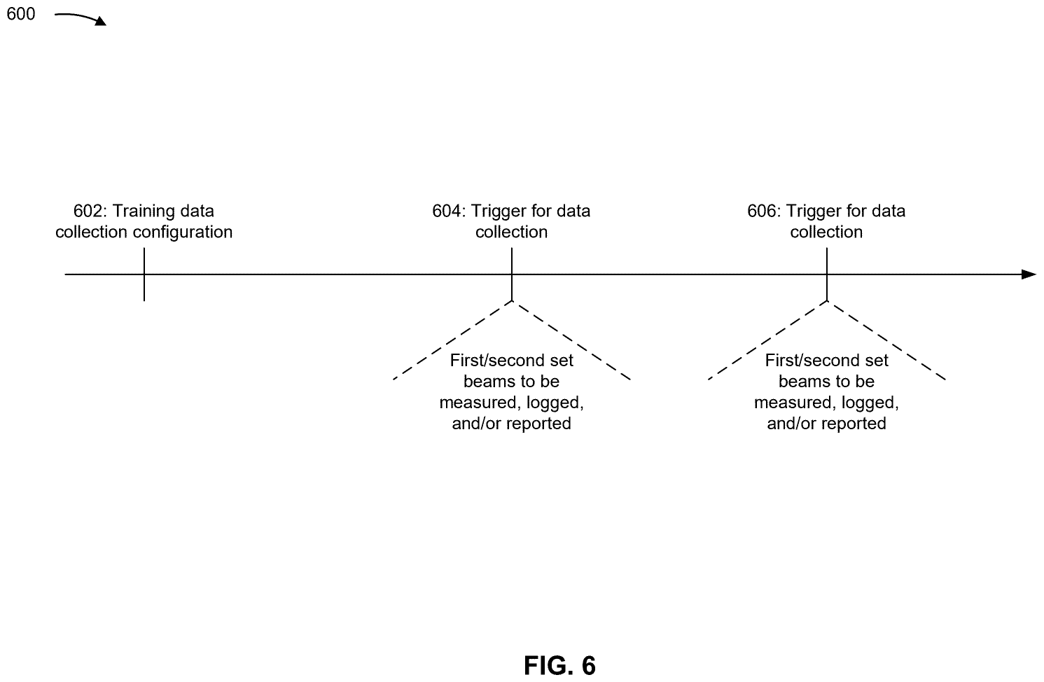

FIG. 6 is a diagram illustrating an example 600 associated with training data collection and reporting, in accordance with the present disclosure.

As shown by reference number 602, a UE may receive, from a network node, a training data collection configuration. The training data collection configuration may indicate one or more measurement objects and one or more reporting or logging objects. After the training data collection configuration is received, the one or more measurement objects and/or the one or more reporting or logging objects may initially be deactivated.

As shown by reference number 604, a first trigger for data collection may cause the UE to perform measurements and reporting/logging. For example, the UE may measure a first set of beams (e.g., Set A) and a second set of beams (e.g., Set B), and then the UE may perform a reporting and/or logging of such measurements. The UE may obtain measurements of configured first set resources and second set resources, and then log and/or report the measurements to the network node. The first trigger for data collection may be based at least in part on an activation or a deactivation of the one or more measurement objects and/or the one or more reporting or logging objects. The activation or the deactivation may be based at least in part on a MAC-CE received from the network node, higher layer signaling received from the network node, a probabilistic trigger for data collection, and/or a trigger based at least in part on a measured RSRP or RSRQ.

As shown by reference number 606, at a later point in time, a second trigger for data collection may cause the UE to again perform the measurements and reporting/logging. The second trigger for data collection may be based at least in part on an activation or a deactivation of the one or more measurement objects and/or the one or more reporting or logging objects. The second trigger may be the same as the first trigger, or the second trigger and the first trigger may be different triggers. For example, the first trigger may be associated with a received MAC-CE, whereas the second trigger may be associated with a measured RSRP or RSRQ.

As indicated above, FIG. 6 is provided as an example. Other examples may differ from what is described with regard to FIG. 6.

FIG. 7 is a diagram illustrating an example 700 associated with training data collection and reporting, in accordance with the present disclosure.

In some aspects, a UE may receive, from a network node, a configuration that indicates one or more L1 measurement objects (shown as “MeasObject” in various Figures, including FIG. 7) and one or more L1 reporting or logging objects. As shown by reference number 702, each L1 measurement object, of the one or more L1 measurement objects, may be associated with a first set of beams (e.g., Set A beams), a second set of beams (e.g., Set B beams), and an associated identifier. For example, as shown in various figures, including FIG. 7, a first L1 measurement object (MeasObject) may be associated with a first Set A (Set A₁), a first set B (Set B₁), and a first associated identifier (ID) (Associated ID₁), and an Mth L1 measurement object (MeasObject) may be associated with an Mth Set A (Set A_{M}), an Mth set B (Set B_{M}), and an Mth associated ID (Associated ID_{M}), where M is an integer. As shown by reference number 704, each L1 measurement object, of the one or more L1 reporting or logging objects, may be associated with a reporting amount, a reporting interval, and a time series. For example, as shown in various figures, including FIG. 7, an L1 reporting or logging object may indicate a first measurement object (MeasObject), which may be associated with a first reporting amount (Reporting Amount₁), a first reporting interval (Reporting Interval₁), and a first time series (Time Series1), and the L1 reporting or logging object may indicate a Kth measurement object (MeasObject), which may be associated with a Kth reporting amount (Reporting Amount_{K}), a Kth reporting interval (Reporting Interval_{K}), and a Kth time series (Time Series_{K}), where K is an integer.

As indicated above, FIG. 7 is provided as an example. Other examples may differ from what is described with regard to FIG. 7.

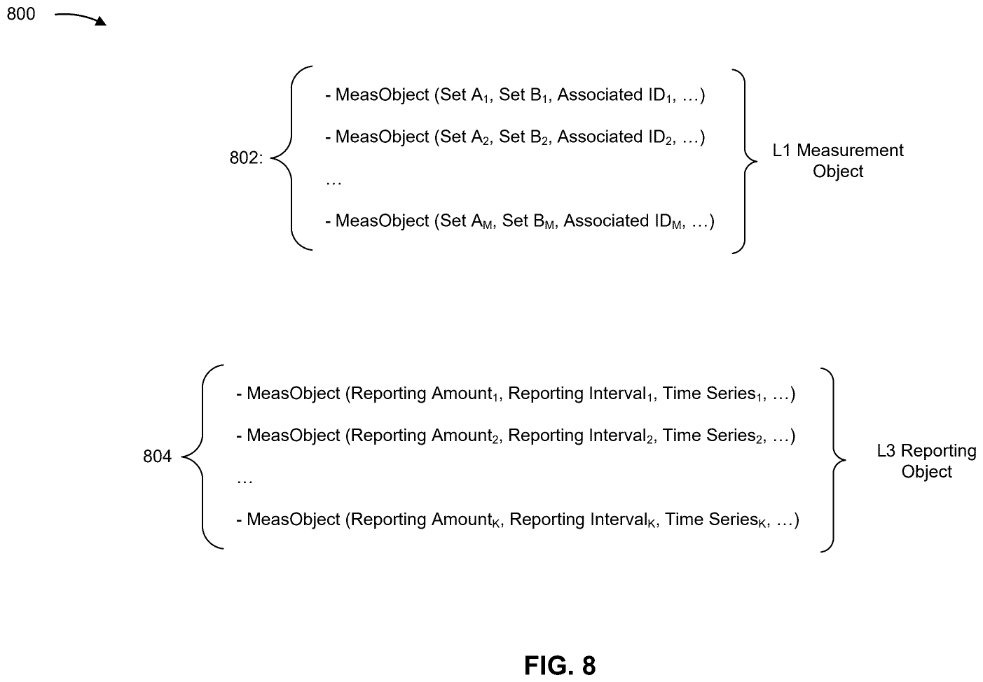

FIG. 8 is a diagram illustrating an example 800 associated with training data collection and reporting, in accordance with the present disclosure.

In some aspects, a UE may receive, from a network node, a configuration that indicates one or more L1 measurement objects and one or more L3 reporting or logging objects. As shown by reference number 802, each L1 measurement object, of the one or more L1 measurement objects, may be associated with a first set of beams (e.g., Set A beams), a second set of beams (e.g., Set B beams), and an associated identifier. As shown by reference number 804, each L3 measurement object, of the one or more L3 reporting or logging objects, may be associated with a reporting amount, a reporting interval, and a time series.

As indicated above, FIG. 8 is provided as an example. Other examples may differ from what is described with regard to FIG. 8.

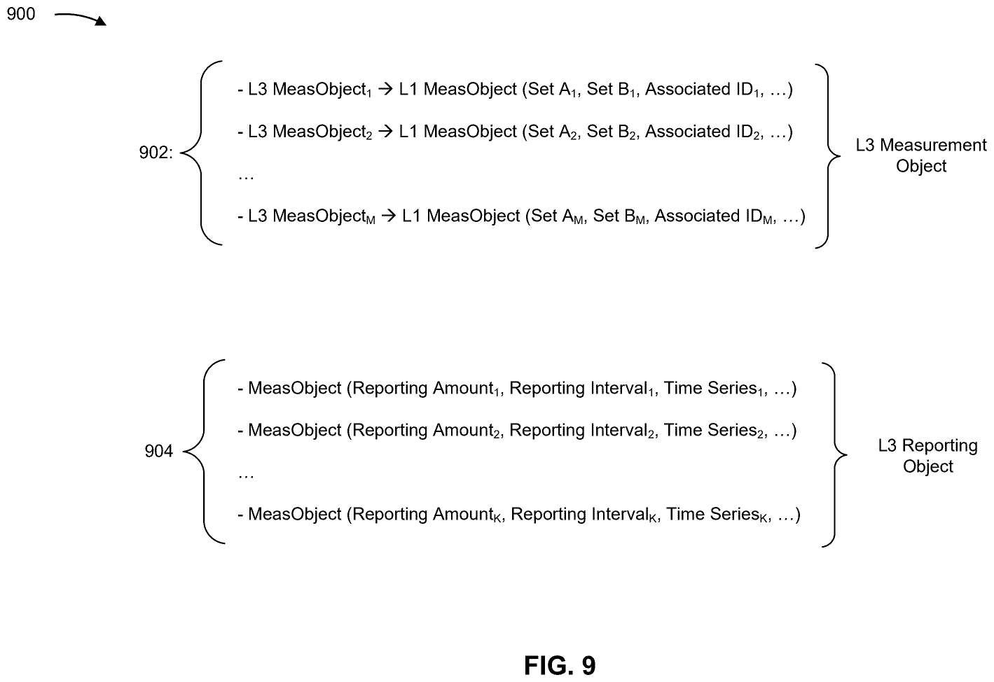

FIG. 9 is a diagram illustrating an example 900 associated with training data collection and reporting, in accordance with the present disclosure.

In some aspects, a UE may receive, from a network node, a configuration that indicates one or more L3 measurement objects and one or more L3 reporting or logging objects. As shown by reference number 902, each L3 measurement object (shown as “L3 MeasObject” in various Figures, including FIG. 9), of the one or more L3 measurement objects, may be associated with an L1 measurement object (shown as “L1 MeasObject” in various Figures, including FIG. 9). The L1 measurement object may be associated with a first set of beams (e.g., Set A beams), a second set of beams (e.g., Set B beams), and an associated identifier. For example, as shown in various figures, including FIG. 9, a first L3 measurement object (L3 MeasObject1) may be associated with a first L1 measurement object (L1 MeasObject), where the first L1 measurement object may be associated with a first Set A (Set A₁), a first set B (Set B1), and a first associated ID (Associated ID₁). An Mth L3 measurement object (L2 MeasObject) may be associated with an Mth L1 measurement object (L1 MeasObject), where the Mth L1 measurement object may be associated with an Mth first Set A (Set A_{M}), an Mth set B (Set B_{M}), and an Mth associated ID (Associated ID_{M}), where M is an integer. As shown by reference number 904, each L3 measurement object, of the one or more L3 reporting or logging objects, may be associated with a reporting amount, a reporting interval, and a time series.

As indicated above, FIG. 9 is provided as an example. Other examples may differ from what is described with regard to FIG. 9.

FIG. 10 is a diagram illustrating an example process 1000 performed, for example, at a UE or an apparatus of a UE, in accordance with the present disclosure. Example process 1000 is an example where the apparatus or the UE (e.g., UE 120) performs operations associated with training data collection and reporting.

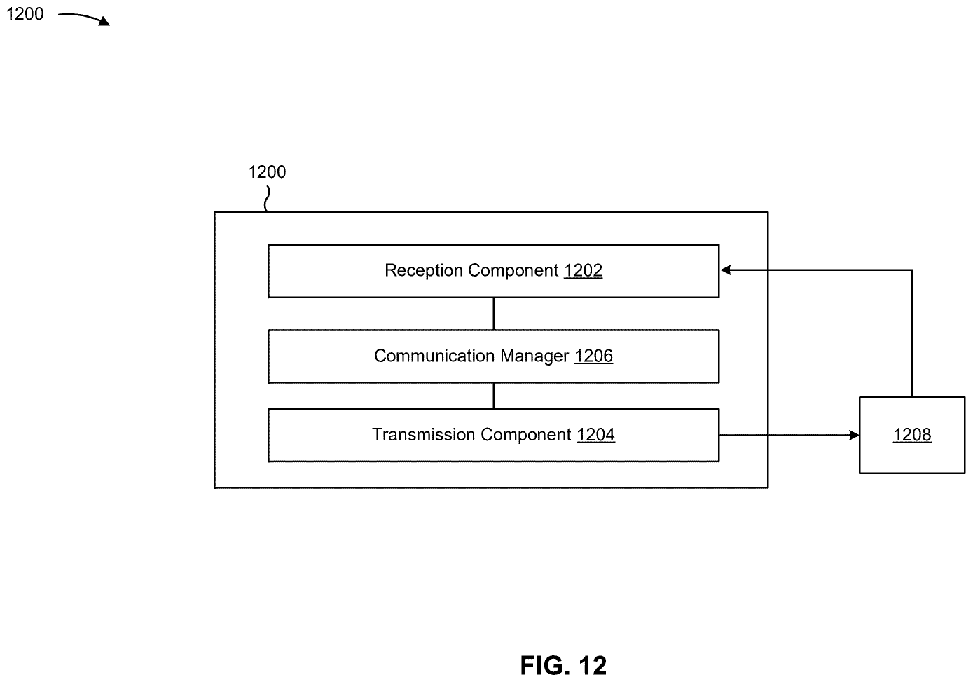

As shown in FIG. 10, in some aspects, process 1000 may include receiving a configuration that indicates one or more measurement objects and one or more reporting or logging objects, wherein a first subset of the one or more measurement objects and the one or more reporting or logging objects are activated at a receipt of the configuration and a second subset of the one or more measurement objects and the one or more reporting or logging objects are deactivated at the receipt of the configuration (block 1010). For example, the UE (e.g., using reception component 1202 and/or communication manager 1206, depicted in FIG. 12) may receive a configuration that indicates one or more measurement objects and one or more reporting or logging objects, wherein a first subset of the one or more measurement objects and the one or more reporting or logging objects are activated at a receipt of the configuration and a second subset of the one or more measurement objects and the one or more reporting or logging objects are deactivated at the receipt of the configuration, as described above with respect to reference number 502 of FIG. 5.

As further shown in FIG. 10, in some aspects, process 1000 may include transmitting, based at least in part on a trigger that activates the one or more measurement objects or the one or more reporting or logging objects, a measurement report that indicates training data based at least in part on the one or more measurement objects or the one or more reporting or logging objects (block 1020). For example, the UE (e.g., using transmission component 1204 and/or communication manager 1206, depicted in FIG. 12) may transmit, based at least in part on a trigger that activates the one or more measurement objects or the one or more reporting or logging objects, a measurement report that indicates training data based at least in part on the one or more measurement objects or the one or more reporting or logging objects, as described above with respect to reference number 506 of FIG. 5.

Process 1000 may include additional aspects, such as any single aspect or any combination of aspects described below and/or in connection with one or more other processes described elsewhere herein.

In a first aspect, process 1000 includes logging measurements for subsequent transmission based at least in part on the one or more measurement objects or the one or more reporting or logging objects.

In a second aspect, alone or in combination with the first aspect, the trigger is configured to activate or deactivate the one or more measurement objects at L1 or L3, and the trigger is configured to activate or deactivate the one or more reporting or logging objects at L1 or L3.

In a third aspect, alone or in combination with one or more of the first and second aspects, process 1000 includes receiving a MAC-CE that triggers the one or more measurement objects and/or the one or more reporting or logging objects to be activated.

In a fourth aspect, alone or in combination with one or more of the first through third aspects, the MAC-CE indicates, for the one or more measurement objects or the one or more reporting or logging objects to be activated or deactivated, one or more of a serving cell identifier, a measurement object identifier, a reporting or logging object identifier, or an activation or deactivation status.

In a fifth aspect, alone or in combination with one or more of the first through fourth aspects, process 1000 includes receiving a higher layer signaling that triggers the one or more measurement objects or the one or more reporting or logging objects to be activated or deactivated, wherein the higher layer signaling indicates, for the one or more measurement objects or the one or more reporting or logging objects to be activated or deactivated, one or more of: a measurement object identifier, a reporting or logging object identifier, or an activation or deactivation status.

In a sixth aspect, alone or in combination with one or more of the first through fifth aspects, process 1000 includes receiving system information via a periodic broadcast or an aperiodic broadcast, wherein the system information indicates, for the one or more measurement objects or the one or more reporting or logging objects to be activated or deactivated, one or more of: a measurement object identifier, a reporting or logging object identifier, or an activation or deactivation status.

In a seventh aspect, alone or in combination with one or more of the first through sixth aspects, the trigger is a probabilistic trigger, and the probabilistic trigger for data collection is based at least in part on a network configuration.

In an eighth aspect, alone or in combination with one or more of the first through seventh aspects, the trigger is based at least in part on one or more measurements of serving cells or beams.

In a ninth aspect, alone or in combination with one or more of the first through eighth aspects, process 1000 includes indicating a number of samples at a defined interval.

In a tenth aspect, alone or in combination with one or more of the first through ninth aspects, the one or more measurement objects include one or more L1 measurement objects, and the one or more reporting or logging objects include one or more L1 reporting objects.

In an eleventh aspect, alone or in combination with one or more of the first through tenth aspects, the one or more measurement objects include one or more L1 measurement objects, and the one or more reporting or logging objects include one or more L3 reporting objects.

In a twelfth aspect, alone or in combination with one or more of the first through eleventh aspects, the one or more measurement objects include one or more L3 measurement objects, and the one or more reporting or logging objects include one or more L3 reporting objects.

In a thirteenth aspect, alone or in combination with one or more of the first through twelfth aspects, the training data is associated with a network-side model training.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network node or an apparatus of a network node, in accordance with the present disclosure. Example process 1100 is an example where the apparatus or the network node (e.g., network node 110) performs operations associated with training data collection and reporting.

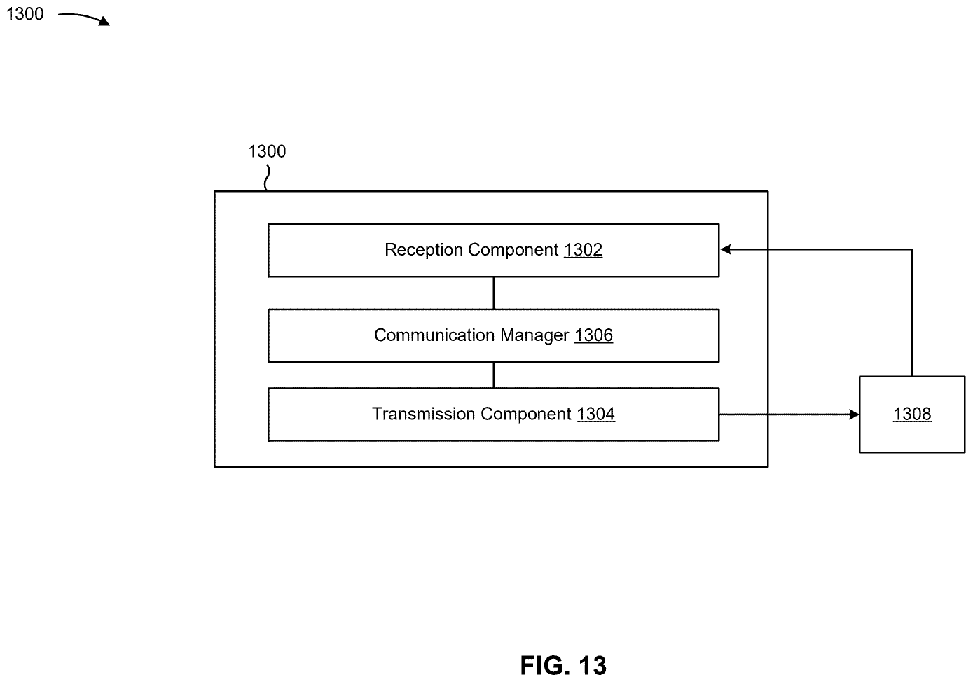

As shown in FIG. 11, in some aspects, process 1100 may include transmitting a configuration that indicates one or more measurement objects and one or more reporting or logging objects, wherein a first subset of the one or more measurement objects and the one or more reporting or logging objects are activated at a receipt of the configuration and a second subset of the one or more measurement objects and the one or more reporting or logging objects are deactivated at the receipt of the configuration (block 1110). For example, the network node (e.g., using transmission component 1304 and/or communication manager 1306, depicted in FIG. 13) may transmit a configuration that indicates one or more measurement objects and one or more reporting or logging objects, wherein a first subset of the one or more measurement objects and the one or more reporting or logging objects are activated at a receipt of the configuration and a second subset of the one or more measurement objects and the one or more reporting or logging objects are deactivated at the receipt of the configuration, as described above with respect to reference number 502 of FIG. 5.

As further shown in FIG. 11, in some aspects, process 1100 may include receiving, based at least in part on a trigger that activates the one or more measurement objects or the one or more reporting or logging objects, a measurement report that indicates training data based at least in part on the one or more measurement objects or the one or more reporting or logging objects (block 1120). For example, the network node (e.g., using reception component 1302 and/or communication manager 1306, depicted in FIG. 13) may receive, based at least in part on a trigger that activates the one or more measurement objects or the one or more reporting or logging objects, a measurement report that indicates training data based at least in part on the one or more measurement objects or the one or more reporting or logging objects, as described above with respect to reference number 506 of FIG. 5.

Process 1100 may include additional aspects, such as any single aspect or any combination of aspects described below and/or in connection with one or more other processes described elsewhere herein.

In a first aspect, process 1100 includes transmitting the configuration via RRC signaling.

In a second aspect, alone or in combination with the first aspect, process 1100 includes transmitting a MAC-CE that triggers the one or more measurement objects and/or the one or more reporting or logging objects to be activated.

In a third aspect, alone or in combination with one or more of the first and second aspects, the MAC-CE indicates, for the one or more measurement objects or the one or more reporting or logging objects to be activated or deactivated, one or more of a serving cell identifier, a measurement object identifier, a reporting or logging object identifier, or an activation or deactivation status.

In a fourth aspect, alone or in combination with one or more of the first through third aspects, process 1100 includes transmitting a higher layer signaling that triggers the one or more measurement objects or the one or more reporting or logging objects to be activated or deactivated, wherein the higher layer signaling indicates, for the one or more measurement objects or the one or more reporting or logging objects to be activated or deactivated, one or more of: a measurement object identifier, a reporting or logging object identifier, or an activation or deactivation status.

In a fifth aspect, alone or in combination with one or more of the first through fourth aspects, process 1100 includes receiving system information via a periodic broadcast or an aperiodic broadcast, wherein the system information indicates, for the one or more measurement objects or the one or more reporting or logging objects to be activated or deactivated, one or more of: a measurement object identifier, a reporting or logging object identifier, or an activation or deactivation status.

In a sixth aspect, alone or in combination with one or more of the first through fifth aspects, the trigger is a probabilistic trigger, and the probabilistic trigger for data collection is based at least in part on a network configuration.

In a seventh aspect, alone or in combination with one or more of the first through sixth aspects, the trigger is based at least in part on one or more measurements of serving cells or beams.

In an eighth aspect, alone or in combination with one or more of the first through seventh aspects, process 1100 includes receiving a number of samples at a defined interval in accordance with a network configuration or a UE implementation.

In a ninth aspect, alone or in combination with one or more of the first through eighth aspects, the one or more measurement objects include one or more L1 measurement objects, and the one or more reporting or logging objects include one or more L1 reporting objects.

In a tenth aspect, alone or in combination with one or more of the first through ninth aspects, the one or more measurement objects include one or more L1 measurement objects, and the one or more reporting or logging objects include one or more L3 reporting objects.

In an eleventh aspect, alone or in combination with one or more of the first through tenth aspects, the one or more measurement objects include one or more L3 measurement objects, and the one or more reporting or logging objects include one or more L3 reporting objects.

In a twelfth aspect, alone or in combination with one or more of the first through eleventh aspects, the training data is associated with a network-side model training.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 5-9. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the UE described in connection with FIG. 1 and FIG. 2. Additionally, or alternatively, one or more components shown in FIG. 12 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive a configuration that indicates one or more measurement objects and one or more reporting or logging objects, wherein a first subset of the one or more measurement objects and the one or more reporting or logging objects are activated at a receipt of the configuration and a second subset of the one or more measurement objects and the one or more reporting or logging objects are deactivated at the receipt of the configuration. The transmission component 1204 may transmit, based at least in part on a trigger that activates the one or more measurement objects or the one or more reporting or logging objects, a measurement report that indicates training data based at least in part on the one or more measurement objects or the one or more reporting or logging objects.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 5-9. Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components of the network node described in connection with FIG. 1 and FIG. 2. Additionally, or alternatively, one or more components shown in FIG. 13 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2. In some aspects, the reception component 1302 and/or the transmission component 1304 may include or may be included in a network interface. The network interface may be configured to obtain and/or output signals for the apparatus 1300 via one or more communications links, such as a backhaul link, a midhaul link, and/or a fronthaul link.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The transmission component 1304 may transmit a configuration that indicates one or more measurement objects and one or more reporting or logging objects, wherein a first subset of the one or more measurement objects and the one or more reporting or logging objects are activated at a receipt of the configuration and a second subset of the one or more measurement objects and the one or more reporting or logging objects are deactivated at the receipt of the configuration. The reception component 1302 may receive, based at least in part on a trigger that activates the one or more measurement objects or the one or more reporting or logging objects, a measurement report that indicates training data based at least in part on the one or more measurement objects or the one or more reporting or logging objects.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving a configuration that indicates one or more measurement objects and one or more reporting or logging objects, wherein a first subset of the one or more measurement objects and the one or more reporting or logging objects are activated at a receipt of the configuration and a second subset of the one or more measurement objects and the one or more reporting or logging objects are deactivated at the receipt of the configuration; and transmitting, based at least in part on a trigger that activates the one or more measurement objects or the one or more reporting or logging objects, a measurement report that indicates training data based at least in part on the one or more measurement objects or the one or more reporting or logging objects.

Aspect 2: The method of Aspect 1, further comprising: logging measurements for subsequent transmission based at least in part on the one or more measurement objects or the one or more reporting or logging objects.

Aspect 3: The method of any of Aspects 1-2, wherein the trigger is configured to activate or deactivate the one or more measurement objects at layer 1 (L1) or layer 3 (L3), and wherein the trigger is configured to activate or deactivate the one or more reporting or logging objects at L1 or L3.

Aspect 4: The method of any of Aspects 1-3, further comprising: receiving a medium access control control element (MAC-CE) that triggers the one or more measurement objects or the one or more reporting or logging objects to be activated.

Aspect 5: The method of Aspect 4, wherein the MAC-CE indicates, for the one or more measurement objects or the one or more reporting or logging objects to be activated or deactivated, one or more of: a serving cell identifier, a measurement object identifier, a reporting or logging object identifier, or an activation or deactivation status.

Aspect 6: The method of any of Aspects 1-5, further comprising: receiving a higher layer signaling that triggers the one or more measurement objects or the one or more reporting or logging objects to be activated or deactivated, wherein the higher layer signaling indicates, for the one or more measurement objects or the one or more reporting or logging objects to be activated or deactivated, one or more of: a measurement object identifier, a reporting or logging object identifier, or an activation or deactivation status.

Aspect 7: The method of any of Aspects 1-6, further comprising: receiving system information via a periodic broadcast or an aperiodic broadcast, wherein the system information indicates, for the one or more measurement objects or the one or more reporting or logging objects to be activated or deactivated, one or more of: a measurement object identifier, a reporting or logging object identifier, or an activation or deactivation status.

Aspect 8: The method of any of Aspects 1-7, wherein the trigger is a probabilistic trigger, and wherein the probabilistic trigger for data collection is based at least in part on a network configuration.

Aspect 9: The method of any of Aspects 1-8, wherein the trigger is based at least in part on one or more measurements of serving cells or beams.

Aspect 10: The method of any of Aspects 1-9, wherein transmitting the measurement report comprises indicating a number of samples at a defined interval.

Aspect 11: The method of any of Aspects 1-10, wherein: the one or more measurement objects include one or more layer 1 measurement objects; and the one or more reporting or logging objects include one or more layer 1 reporting objects.

Aspect 12: The method of any of Aspects 1-11, wherein: the one or more measurement objects include one or more layer 1 measurement objects; and the one or more reporting or logging objects include one or more layer 3 reporting or logging objects.

Aspect 13: The method of any of Aspects 1-12, wherein: the one or more measurement objects include one or more layer 3 measurement objects; and the one or more reporting or logging objects include one or more layer 3 reporting or logging objects.

Aspect 14: The method of any of Aspects 1-13, wherein the training data is associated with a network-side model training.

Aspect 15: A method of wireless communication performed by a network node, comprising: transmitting a configuration that indicates one or more measurement objects and one or more reporting or logging objects, wherein a first subset of the one or more measurement objects and the one or more reporting or logging objects are activated at a receipt of the configuration and a second subset of the one or more measurement objects and the one or more reporting or logging objects are deactivated at the receipt of the configuration; and receiving, based at least in part on a trigger that activates the one or more measurement objects or the one or more reporting or logging objects, a measurement report that indicates training data based at least in part on the one or more measurement objects or the one or more reporting or logging objects.

Aspect 16: The method of Aspect 15, wherein transmitting the configuration is via radio resource control (RRC) signaling.

Aspect 17: The method of any of Aspects 15-16, further comprising: transmitting a medium access control control element (MAC-CE) that triggers the one or more measurement objects or the one or more reporting or logging objects to be activated.

Aspect 18: The method of Aspect 17, wherein the MAC-CE indicates, for the one or more measurement objects or the one or more reporting or logging objects to be activated or deactivated, one or more of: a serving cell identifier, a measurement object identifier, a reporting or logging object identifier, or an activation or deactivation status.

Aspect 19: The method of any of Aspects 15-18, further comprising: transmitting a higher layer signaling that triggers the one or more measurement objects or the one or more reporting or logging objects to be activated or deactivated, wherein the higher layer signaling indicates, for the one or more measurement objects or the one or more reporting or logging objects to be activated or deactivated, one or more of: a measurement object identifier, a reporting or logging object identifier, or an activation or deactivation status.

Aspect 20: The method of any of Aspects 15-19, further comprising: transmitting system information via a periodic broadcast or an aperiodic broadcast, wherein the system information indicates, for the one or more measurement objects or the one or more reporting or logging objects to be activated or deactivated, one or more of: a measurement object identifier, a reporting or logging object identifier, or an activation or deactivation status.

Aspect 21: The method of any of Aspects 15-20, wherein the trigger is a probabilistic trigger, and wherein the probabilistic trigger for data collection is based at least in part on a network configuration.

Aspect 22: The method of any of Aspects 15-21, wherein the trigger is based at least in part on one or more measurements of serving cells or beams.

Aspect 23: The method of any of Aspects 15-22, wherein receiving the measurement report comprises receiving a number of samples at a defined interval in accordance with a network configuration or a UE implementation.

Aspect 24: The method of any of Aspects 15-23, wherein: the one or more measurement objects include layer 1 measurement objects; and the one or more reporting or logging objects include layer 1 reporting objects.

Aspect 25: The method of any of Aspects 15-24, wherein: the one or more measurement objects include layer 1 measurement objects; and the one or more reporting or logging objects include layer 3 reporting or logging objects.

Aspect 26: The method of any of Aspects 15-25, wherein: the one or more measurement objects include layer 3 measurement objects; and the one or more reporting or logging objects include layer 3 reporting or logging objects.

Aspect 27: The method of any of Aspects 15-26, wherein the training data is associated with a network-side model training.

Aspect 28: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-14.

Aspect 29: An apparatus for wireless communication at a device, the apparatus comprising one or more memories and one or more processors coupled to the one or more memories, the one or more processors configured to cause the device to perform the method of one or more of Aspects 1-14.

Aspect 30: An apparatus for wireless communication, the apparatus comprising at least one means for performing the method of one or more of Aspects 1-14.

Aspect 31: A non-transitory computer-readable medium storing code for wireless communication, the code comprising instructions executable by one or more processors to perform the method of one or more of Aspects 1-14.

Aspect 32: A non-transitory computer-readable medium storing a set of instructions for wireless communication, the set of instructions comprising one or more instructions that, when executed by one or more processors of a device, cause the device to perform the method of one or more of Aspects 1-14.

Aspect 33: A device for wireless communication, the device comprising a processing system that includes one or more processors and one or more memories coupled with the one or more processors, the processing system configured to cause the device to perform the method of one or more of Aspects 1-14.

Aspect 34: An apparatus for wireless communication at a device, the apparatus comprising one or more memories and one or more processors coupled to the one or more memories, the one or more processors individually or collectively configured to cause the device to perform the method of one or more of Aspects 1-14.

Aspect 35: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 15-27.

Aspect 36: An apparatus for wireless communication at a device, the apparatus comprising one or more memories and one or more processors coupled to the one or more memories, the one or more processors configured to cause the device to perform the method of one or more of Aspects 15-27.

Aspect 37: An apparatus for wireless communication, the apparatus comprising at least one means for performing the method of one or more of Aspects 15-27.

Aspect 38: A non-transitory computer-readable medium storing code for wireless communication, the code comprising instructions executable by one or more processors to perform the method of one or more of Aspects 15-27.

Aspect 39: A non-transitory computer-readable medium storing a set of instructions for wireless communication, the set of instructions comprising one or more instructions that, when executed by one or more processors of a device, cause the device to perform the method of one or more of Aspects 15-27.

Aspect 40: A device for wireless communication, the device comprising a processing system that includes one or more processors and one or more memories coupled with the one or more processors, the processing system configured to cause the device to perform the method of one or more of Aspects 15-27.

Aspect 41: An apparatus for wireless communication at a device, the apparatus comprising one or more memories and one or more processors coupled to the one or more memories, the one or more processors individually or collectively configured to cause the device to perform the method of one or more of Aspects 15-27.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication, comprising:
one or more memories; and
one or more processors coupled to the one or more memories, the one or more processors individually or collectively configured to:
receive a configuration that indicates one or more measurement objects and one or more reporting or logging objects, wherein a first subset of the one or more measurement objects and the one or more reporting or logging objects are activated at a receipt of the configuration and a second subset of the one or more measurement objects and the one or more reporting or logging objects are deactivated at the receipt of the configuration; and
transmit, based at least in part on a trigger that activates the one or more measurement objects or the one or more reporting or logging objects, a measurement report that indicates training data based at least in part on the one or more measurement objects or the one or more reporting or logging objects.

2. The apparatus of claim 1, wherein the one or more processors are individually or collectively configured to:
log measurements for subsequent transmission based at least in part on the one or more measurement objects or the one or more reporting or logging objects.

3. The apparatus of claim 1, wherein the trigger is configured to activate or deactivate the one or more measurement objects at layer 1 (L1) or layer 3 (L3), and wherein the trigger is configured to activate or deactivate the one or more reporting or logging objects at L1 or L3.

4. The apparatus of claim 1, wherein the one or more processors are individually or collectively configured to:
receive a medium access control control element (MAC-CE) that triggers the one or more measurement objects or the one or more reporting or logging objects to be activated or deactivated.

5. The apparatus of claim 4, wherein the MAC-CE indicates, for the one or more measurement objects or the one or more reporting or logging objects to be activated or deactivated, one or more of: a serving cell identifier, a measurement object identifier, a reporting or logging object identifier, or an activation or deactivation status.

6. The apparatus of claim 1, wherein the one or more processors are individually or collectively configured to:
receive a higher layer signaling that triggers the one or more measurement objects or the one or more reporting or logging objects to be activated or deactivated, wherein the higher layer signaling indicates, for the one or more measurement objects or the one or more reporting or logging objects to be activated or deactivated, one or more of: a measurement object identifier, a reporting or logging object identifier, or an activation or deactivation status.

7. The apparatus of claim 1, wherein the one or more processors are individually or collectively configured to:
receive system information via a periodic broadcast or an aperiodic broadcast, wherein the system information indicates, for the one or more measurement objects or the one or more reporting or logging objects to be activated or deactivated, one or more of: a measurement object identifier, a reporting or logging object identifier, or an activation or deactivation status.

8. The apparatus of claim 1, wherein the trigger is a probabilistic trigger, and wherein the probabilistic trigger for data collection is based at least in part on a network configuration.

9. The apparatus of claim 1, wherein the trigger is based at least in part on one or more measurements of serving cells or beams.

10. The apparatus of claim 1, wherein the one or more processors, to transmit the measurement report, are individually or collectively configured to:
indicate a number of samples at a defined interval.

11. The apparatus of claim 1, wherein:
the one or more measurement objects include one or more layer 1 measurement objects; and
the one or more reporting or logging objects include one or more layer 1 reporting objects.

12. The apparatus of claim 1, wherein:
the one or more measurement objects include one or more layer 1 measurement objects; and
the one or more reporting or logging objects include one or more layer 3 reporting or logging objects.

13. The apparatus of claim 1, wherein:
the one or more measurement objects include one or more layer 3 measurement objects; and
the one or more reporting or logging objects include one or more layer 3 reporting or logging objects.

14. The apparatus of claim 1, wherein the training data is associated with a network-side model training.

15. An apparatus for wireless communication, comprising:
one or more memories; and
one or more processors coupled to the one or more memories, the one or more processors individually or collectively configured to:
transmit a configuration that indicates one or more measurement objects and one or more reporting or logging objects, wherein a first subset of the one or more measurement objects and the one or more reporting or logging objects are activated at a receipt of the configuration and a second subset of the one or more measurement objects and the one or more reporting or logging objects are deactivated at the receipt of the configuration; and
receive, based at least in part on a trigger that activates the one or more measurement objects or the one or more reporting or logging objects, a measurement report that indicates training data based at least in part on the one or more measurement objects or the one or more reporting or logging objects.

16. The apparatus of claim 15, wherein the one or more processors are individually or collectively configured to:
transmit a medium access control control element (MAC-CE) that triggers the one or more measurement objects or the one or more reporting or logging objects to be activated, wherein the MAC-CE indicates, for the one or more measurement objects or the one or more reporting or logging objects to be activated or deactivated, one or more of: a serving cell identifier, a measurement object identifier, a reporting or logging object identifier, or an activation or deactivation status; or
transmit a higher layer signaling or system information that triggers the one or more measurement objects or the one or more reporting or logging objects to be activated, wherein the system information is transmitted via a periodic broadcast or an aperiodic broadcast, and wherein the higher layer signaling or the system information indicates, for the one or more measurement objects or the one or more reporting or logging objects to be activated or deactivated, one or more of: a measurement object identifier, a reporting or logging object identifier, or an activation or deactivation status.

17. The apparatus of claim 15, wherein the trigger is a probabilistic trigger, and wherein the probabilistic trigger for data collection is based at least in part on a network configuration.

18. The apparatus of claim 15, wherein the trigger is based at least in part on one or more measurements of serving cells or beams.

19. The apparatus of claim 15, wherein:
the one or more measurement objects include one or more layer 1 measurement objects or one or more layer 3 measurement objects; and
the one or more reporting or logging objects include one or more layer 1 reporting objects or one or more layer 3 reporting or logging objects.

20. A method of wireless communication performed by a user equipment (UE), comprising:
receiving a configuration that indicates one or more measurement objects and one or more reporting or logging objects, wherein a first subset of the one or more measurement objects and the one or more reporting or logging objects are activated at a receipt of the configuration and a second subset of the one or more measurement objects and the one or more reporting or logging objects are deactivated at the receipt of the configuration; and
transmitting, based at least in part on a trigger that activates the one or more measurement objects or the one or more reporting or logging objects, a measurement report that indicates training data based at least in part on the one or more measurement objects or the one or more reporting or logging objects.
